(19) United States
(12) Patent Application Publication
(10) Pub. No.: US 2022/0253699 A1
(43) Pub. Date: Aug. 11, 2022

(54) MACHINE LEARNING-BASED ANOMALY DETECTION

(71) Applicant: YISSUM RESEARCH DEVELOPMENT COMANY OF THE HEBREW UNIVERSITY OF JERUSALEM LTD., Jerusalem (IL)

(72) Inventors: Yedid HOSHEN, Jerusalem (IL); Liron BERGMAN, Jerusalem (IL)

(21) Appl. No.: 17/619,240

(22) PCT Filed: Jun. 18, 2020
(86) PCT No.: PCT/IL2020/050680

§ 371 Date: Dec. 14, 2021

Related U.S. Application Data
(60) Provisional application No. 62/866,268, filed on Jun. 25, 2019.
(60) Provisional application No. 62/863,577, filed on Jun. 19, 2019.

(51) Int. Cl. G06N 3/08; G06N 3/04

(52) U.S. Cl. CPC G06N 3/08; G06N 3/0454

(57) ABSTRACT

A system comprising at least one hardware processor; and a non-transitory computer-readable storage medium having stored thereon program instructions, the program instructions executable by the at least one hardware processor to: receive, as input, a plurality of data instances representing, at least in part, normal data, apply, to each of the data instances, one or more transformations selected from a set of transformations, to generate a set of transformed data instances, and at a training stage, train a machine learning model on a training set comprising: (i) the set of transformed data instances, and (ii) labels indicating the transformation applied to each of the transformed data instances in the set, to predict a transformation from the set applied to a target data instance.

### CROSS REFERENCE TO RELATED APPLICATIONS

This application claims priority from U.S. Provisional Patent Application Nos. 62/863,577, filed Jun. 19, 2019, and 62/866,268, filed Jun. 25, 2019, the contents of both of which are incorporated by reference herein in their entirety.

### BACKGROUND

This invention relates to the field of machine learning.

Detecting anomalies in data is a key ability for humans and for artificial intelligence. Humans often rely on anomaly detection as an early indication of danger. Artificial intelligence anomaly detection systems are being used to detect, e.g., credit card fraud and cyber intrusion, to predict maintenance requirements of industrial equipment, or for identifying investment opportunities.

The typical anomaly detection setting is a single class classification task, where the objective is to classify data as normal or anomalous. By detecting a different pattern from those seen in the past, it is possible to raise an alert or trigger specific action.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in an embodiment, a system comprising at least one hardware processor; and a non-transitory computer-readable storage medium having stored thereon program instructions, the program instructions executable by the at least one hardware processor to: receive, as input, a plurality of data instances representing, at least in part, normal data, apply, to each of the data instances, one or more transformations selected from a set of transformations, to generate a set of transformed data instances, and at a training stage, train a machine learning model on a training set comprising: (i) the set of transformed data instances, and (ii) labels indicating the transformation applied to each of the transformed data instances in the set, to predict a transformation from the set applied to a target data instance.

There is also provided, in an embodiment, a method comprising: receiving, as input, a plurality of data instances representing, at least in part, normal data, applying, to each of the data instances, one or more transformations selected from a set of transformations, to generate a set of transformed data instances, and at a training stage, training a machine learning model on a training set comprising: (i) the set of transformed data instances, and (ii) labels indicating the transformation applied to each of the transformed data instances in the set, to predict a transformation from the set applied to a target data instance.

There is further provided, in an embodiment, a computer program product comprising a non-transitory computer-readable storage medium having program code embodied therewith, the program code executable by at least one hardware processor to: receive, as input, a plurality of data instances representing, at least in part, normal data, apply, to each of the data instances, one or more transformations selected from a set of transformations, to generate a set of transformed data instances, and at a training stage, train a machine learning model on a training set comprising: (i) the set of transformed data instances, and (ii) labels indicating the transformation applied to each of the transformed data instances in the set, to predict a transformation from the set applied to a target data instance.

In some embodiments, the program instructions are further executable to apply, and the method further comprises applying, at an inference stage, the trained machine learning model to the target data instance, to predict the transformation applied to the target data instance.

In some embodiments, the prediction has a confidence score, and wherein the confidence score is indicative of an anomaly value associated with the target data instance.

In some embodiments, the program instructions are further executable to apply, and the method further comprises applying, at an inference stage, the trained machine learning model to a plurality of transformations of the target data instance to predict each of the plurality of transformations, and wherein the anomaly value is an aggregate of all of the confidence scores associated with each of the predictions.

In some embodiments, the normal data is within a distribution, and wherein the anomaly value indicates how far the target data instance is from the distribution.

In some embodiments, the program instructions are further executable to further train, and the method further comprises further training, at least a portion of the trained machine learning model on a training set comprising: (i) data instances representing a plurality of attributes, and (ii) labels indicating attributes, to predict the attribute in an attribute-based target data instance.

In some embodiments, the plurality of data instances comprise at least one of: general structured data and general unstructured data.

In some embodiments, the plurality of data instances comprise any one or more of: numerical data, univariate time-series data, multivariate time-series data, attribute-based data, vectors, graph data, image data, video data, and tabular data.

In some embodiments, the one or more transformations comprise affine and nonaffine transformations.

In some embodiments, the one or more transformations are one or more of: geometric transformations, permutations, orthogonal matrices, affine matrices, application of a neural network, logarithmic transformations, exponential transformations, and multiplication operations.

In some embodiments, the data instances in the set of transformed data instances are labeled with the labels.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 is a flowchart of the functional steps in an automated machine learning-based detection of anomalous patterns in general data, according to some embodiments of the present disclosure;

FIGS. 2A-2B show classification error for the present method as a function of percentage of the anomalous examples in the training set, according to some embodiments of the present disclosure;

FIGS. 3A-3D show plots of the number of auxiliary tasks vs. the anomaly detection accuracy, according to some embodiments of the present disclosure; and

FIGS. 4A-4C show plots of the degree of contamination vs. the anomaly detection accuracy, according to some embodiments of the present disclosure.

### DETAILED DESCRIPTION

Disclosed herein are a system, method, and computer program product for automated machine learning-based detection of anomalous patterns in general data. In some embodiments, the present disclosure may provide for detecting anomalous patterns in any type of general data, which may be structured (e.g., as graphs, spatially, or temporally) or unstructured. In some embodiments, general data of the present disclosure may be, e.g., numerical, any univariate and/or multivariate time-series data, attribute-based data, vectors (structured or unstructured), graphs, image data, video data, tabular data, and/or a combination of any thereof. In some embodiments, the present model does not require any a-priori domain knowledge and/or data assumptions.

In some embodiments, a machine learning model of the present disclosure may be trained for detecting anomalies in general data, based on a set of generated auxiliary tasks.

In some embodiments, the present model is based on semi-supervised training, wherein a training set of the present disclosure comprises ‘normal’ data instances, i.e., containing no anomalous data. In some embodiments, a training method of the present disclosure may be at least partially supervised.

In some embodiments, the present disclosure provides for learning a feature extractor using a neural network, which maps the original input data into a feature representation. In some embodiments, a set of transformations, e.g., affine and/or non-affine transformations may be applied to the training data, to generate a set of transformed instances of the data. In some embodiments an arbitrary number of transformation may be selected. In some embodiments, transformations may be randomly selected and/or manually selected.

In some embodiments, the transformations may comprise any one or more of: any geometric transformations, permutations, orthogonal matrices, affine matrices, application of a neural network, logarithmic transformations, exponential transformations, multiplication operations, and the like. In some embodiments, in the case of image transformation, transformation employed by the present disclosure do not preserve distances between pairs of pixels.

In some embodiments, the present method transforms the training data instances into M subspaces, wherein each subspace is mapped to the learned feature space for the input data, and wherein the different transformation subspaces are well separated, such that inter-class separation is larger than intra-class separation. In some embodiments, a machine learning model, e.g., a classifier, may be trained to predict the applied transformations of the data instances, wherein a prediction probability with respect to transformation m may be indicative of a normality or anomaly of a target data point. In some embodiments, a prediction probability with respect to transformation m, i.e., indicating a distance from a center of a subspace form in the feature space, may be correlated with the likelihood of anomaly of the classified data instance. This criterion then may be used to determine if a new data point is normal or anomalous.

In some embodiments, after training the classifier, at an inference stage, the classifier may be applied to target data containing anomalous patterns, wherein the aggregate classification probability be indicative of data anomaly, such that normal target data should reflect higher prediction and/or classification probability than anomalous data.

In some embodiments, a training method of the present disclosure facilitates the creation of a suitable training set by annotating and/or labeling each transformed data instance in the training set with a label indicated an index of the transformation. In some embodiments, this method is advantageous compared as compared to fully supervised training, which requires obtaining data that is typically difficult to obtain, and labeling it with a ground truth annotation. The present method is further is more robust than the fully-unsupervised case. The present inventors have validated the present method on a range of datasets from the cyber security and medical domains.

By way of background, the typical anomaly detection setting is a one-class classification task, where the objective is to classify data as either normal or anomalous. In the basic anomaly detection problem, a sample from a “normal” class of instances is within some distribution, and the goal is to construct a classifier capable of detecting out-of-distribution “abnormal” instances.

The challenge in this task stems from the need to detect a different pattern from those encountered during training. This is fundamentally different from supervised learning tasks, in which examples of all data classes are observed during the training process. In supervised anomaly detection, training examples of normal and anomalous patterns must be provided. However, obtaining anomalous training samples may not always be possible. For example, in cyber security settings, obtaining training instances of new, unknown cyber-attacks may be difficult. At the other extreme, fully unsupervised anomaly detection obtains a stream of data containing normal and anomalous patterns, and attempts to detect the anomalous data.

Often in supervised classification, systems hope to perform well on normal data, whereas anomalous data is considered noise. The goal of an anomaly detection system is to specifically detect extreme cases, which are highly variable and hard to predict. This makes the task of anomaly detection challenging and often poorly specified.

Many anomaly detection methods have been proposed over the last few decades. They can be broadly classified into classification, reconstruction and statistically based methods. Classification-based methods use labeled normal and anomalous examples to train a classifier to perform separation between space regions containing normal data from all other regions. Learning a good feature space for performing such separation may be performed, e.g., by the classic kernel methods, as well as deep learning approaches. One of the main challenges in unsupervised (or semi-supervised) learning is providing an objective for learning features that are relevant to the task of interest. One method for learning good representations in a self-supervised way is by training a neural network to solve an auxiliary task for which obtaining data is free or at least very inexpensive. Reconstruction-based methods attempt to reconstruct all normal data using a model containing a bottleneck. Reconstruction-based methods are very sensitive to the similarity measure used to compute the quality of reconstruction, which requires careful feature engineering. Statistical-methods attempt to learn the probability distribution of the normal data. The assumption is that test-set normal data will have high likelihood under this model, whereas anomalous data will have low likelihood. Statistical-methods vary in the method for estimating the probability distribution.

In some embodiments, the present disclosure may have multiple practical applications, including, but no limited to:
Cyber Intrusion Detection: Defending cyber systems is of critical importance to governments, defense organizations, and industry critical systems. Cyber intrusion detection can help protect user data on commercial servers and social networks, as well as on personal computing platforms (PCs, laptops, mobile phones, tablets, etc.). Supervised machine learning systems for detecting hostile intrusions have the significant drawback of requiring labelled data from the attacks that the defender is trying to detect. This is, however, not likely to be possible, as the defender is typically unaware of new attacks because the very purpose of anomaly detection is to attempt to discover new attacks unseen before. Accordingly, the present disclosure is highly effective on this class of tasks.
Emerging Medical Condition Detection: Medical diagnostics is essential for human well-being and has important economic value. AI systems for detecting medical conditions suffer from several challenges, e.g., the high costs of obtaining and annotating training datasets, lack of knowledge with respect to previously unknown medical conditions. Anomaly detection presents a particularly attractive method for detecting new, emerging medical conditions.
Fault Detection and Predictive Maintenance: The increasing use of hardware components which can transmit telemetry data regarding their condition and operations presents new opportunities for automated remote malfunction detection based on anomaly detection. This may also be used as part of preventive maintenance, based on predicting the development of imminent faulty conditions before their occurrence.
Surveillance: Security operators attempt to find unusual patterns in the facility under their protection, for further inspection. The surveillance data may come in many forms, such as video, audio, single-images, etc. Due to the expense and limited attention span of human operators, artificial intelligence security operators are in high-demand. As the anomalous patterns which the operator attempts to detect are highly diverse, it is not typically possible to use supervised machine learning for creating AI operators. Anomaly detection, however, which detects deviations from normal behavior, is much more suitable for the task.
Credit Card Fraud: Credit cards are a convenient payment method, but also present significant fraud risk. Credit card fraud detection and prevention presents a significant challenge for credit card companies and other e-payment companies. As malicious agents constantly adapt their methods, using previous fraud patterns for training supervised fraud detectors does not yield robust results. Instead, anomaly detection for detecting anomalous patterns presents a very promising approach.

### General—Classification-Based Anomaly Detection

Assume all data lies in space R^{L}, where L is the data dimension. Normal data lie in subspace X⊂R^{L}. Assume further that all anomalies lie outside X. To detect anomalies, one could therefore build a classifier C, such that C(x)=1 if x∈X, and C(x)=0 if x∈R^{L}\X.

One-class classification methods attempt to learn C directly as P(x∈X). Classical approaches have learned a classifier either in input space or in a kernel space. Recently, Deep-SVDD learned end-to-end to transform data to an isotropic feature space f(x) and fit the minimal hypersphere of radius R and center c₀ around the features of the normal training data. Test data is classified as anomalous if the following normality score is positive: ∥f(x)−c₀∥²−R². Learning an effective feature space is not a simple task, as the trivial solution of f(x)=0∀x results in the smallest hypersphere.

Known geometric-transformation classification methods first transforms the normal data subspace X into M subspaces X₁ . . . X_{M}. This is done by transforming each data instance x∈X using M different geometric transformations (rotation, reflection, translation) into T(x,1) . . . T(x,M). The transformations set an auxiliary task of learning a classifier able to predict the transformation label m given transformed data point T(x,m). As the training set consists of normal data only, each sample is x∈X and the transformed sample is in ∪ₘ Xₘ. The method attempts to estimate the following conditional probability:

$$P ( {m}^{′} \vert T ( x , m ) ) = \frac{P ( T ( x , m ) ∈ {X}_{m ′} ) P ( m ′ )}{{\sum }_{\tilde{m}} P ( T ( x , m ) ∈ {X}_{\tilde{m}} ) P ( \tilde{m} )} = \frac{P ( T ( x , m ) ∈ {x}_{m ′} )}{{\sum }_{\tilde{m}} P ( T ( x , m ) ∈ {X}_{\tilde{m}} )} \qquad ( 1 )$$

where the second equality follows by design of the training set, and where every training sample is transformed exactly once by each transformation leading to equal priors.

For anomalous data x∈R^{L}\X, by construction of the subspace, if the transformations T are one-to-one, it follows that the transformed sample does not fall in the appropriate subspace: T(x,m)∈R^{L}\Xₘ. The method uses P(m|T(x,m)) as a score for determining if x is anomalous, i.e., that x∈R^{L}\X, where samples with low probabilities P(m|T(x,m)) are given high anomaly scores.

A significant issue with this methodology is that the learned classifier P(m′|T(x,m)) is only valid for samples x∈X which were found in the training set. For x∈R^{L}\X the result should be P(T(x,m)∈X_{m′})=0 for all m=1 . . . M, as the transformed x is not in any of the subsets. This makes the anomaly score P(m′|T(x,m)) have very high variance for anomalies.

One way to overcome this issue is by using examples of anomalies xₐ and training

$$P ( m \vert T ( x , m ) ) = \frac{1}{M}$$

on anomalous data. This corresponds to the supervised scenario. Although getting such supervision is possible for some image tasks, where large external datasets can be obtained, this is not possible in the general case, e.g., for tabular data which exhibits much more variation between datasets.

### Anomaly Detection by Generalization on an Auxiliary Task

Let us define each data instance x. To indicate that the data is normal, it may be denoted xₙ, whereas anomalous data is denoted xₐ. A training set X_{Tr}=xₙ, xₙ²; . . . , xₙ^{N}^{ₜᵣₐᵢₙ} contains only normal examples, whereas a test set X_{Te} contains Nₙ normal and Nₐ anomalous examples. A set of L transformation may be defined as T, T₂, . . . , T_{L} and applied to the raw data. Each data point x is therefore transformed into L different labeled pairs:

x→((T(x),1),(T₂(x),2), . . . ,(T_{L}(x),L)).

A classifier C, implemented, e.g., as a neural network with L outputs followed by a Softmax activation, is trained to predict the transformation label probabilities given the transformed example x=T(x):

P(l=l|x)=C(x).

The classifier C is optimized to assign the highest probability to the correct label l (out of all labels 1, 2, . . . , L). The optimization loss function L is:

L=Σ_{x∈T}_{ᵣ}Σₗ log(P(l=l|T_{L}(x)))

It is expected that C trained on the empirical normal distribution will generalize well to test data coming from the normal distribution, and will not generalize as well on test data coming from different distributions, particularly anomalous data.

At inference, for every example x, an anomaly score may be computed using the product of the predicted probability of the correct transformations (for numerical stability, the sum log-probability is used).

$$Score = {\sum }_{l} log ( P ( l = l \vert {T}_{l} ) ( x ) ) )$$

For the method to work, the scores for anomalies should be higher than normal data (Score(xₐ)>Score(xₙ)). This is a consequence of the generalization property discussed above.

### Transformations for General Data

With respect to image data, carefully selected image-processing operations may be selected for self-learning features. Such operations are specialized to images and do not generalize to non-image operations.

In some embodiments, the present disclosure provides for a set of transformations which perform well as an auxiliary task for anomaly detection in general data.

In some embodiments, the following categories of transformations may apply:
Permutations: This is the simplest examined transformation. Each operation consists of a random shuffling of the input vector elements. Assume the input vector x has M elements. Let (x) define a shuffle operation such that (x)=[x₍, x₍₂, . . . , x₍]. The transformation family may be defined such that each i ( ) corresponds to a different random shuffle:

Ti(x)=i(x).
It is noted that the geometric image transformations (rotation, translation) are a special case of the permutation transformations dedicated for images. Image rotations ensure that neighboring pixels will remain nearby after the rotation. However, in the present disclosure, no structural assumptions are made with respect to the data (which in the general case does not need to satisfy these properties). This class of permutations is therefore much richer than image rotations.
Orthogonal Transformation: To generalize random permutations, random orthogonal matrices may be used. The orthogonal transformation is simply a rotation in each orthogonal transformation consists of a matrix Rₗ. The operation family is therefore defined as:

Ti(x)=+ix
Affine Transformation: To generalize random orthogonal matrices, the random affine class may be used. An affine transformation is simply a matrix multiplication. Each matrix has dimensions d₀ᵤₜXd_{data}, where dₒᵤₜ is the output dimension and d_{data} is the input data dimension. Each affine transformation consists of a matrix Wᵢ, each element is randomly sampled from an IID normal distribution. The operation family is therefore defined as:

Ti(x)=Wix.

In some embodiments, transformation may further include nonaffine transformation including, but not limited to, logarithmic transformations, exponential transformations, multiplication operations, and the like.

In addition, in some embodiments, input data may be preprocessed using, e.g., one or more methods including, but not limited to: principal component analysis (PCA), independent component analysis (ICA), singular value decomposition (SVD), whitening transformation, elementwise mean and standard deviation computed over the training set, and the like. In some embodiments, binary attributes are not normalized.

### Distance-Based Multiple Transformation Classification

Accordingly, in some embodiments, the present disclosure provides for a novel method to overcome the generalization issues affecting known geometric-transformation classification methods as noted above.

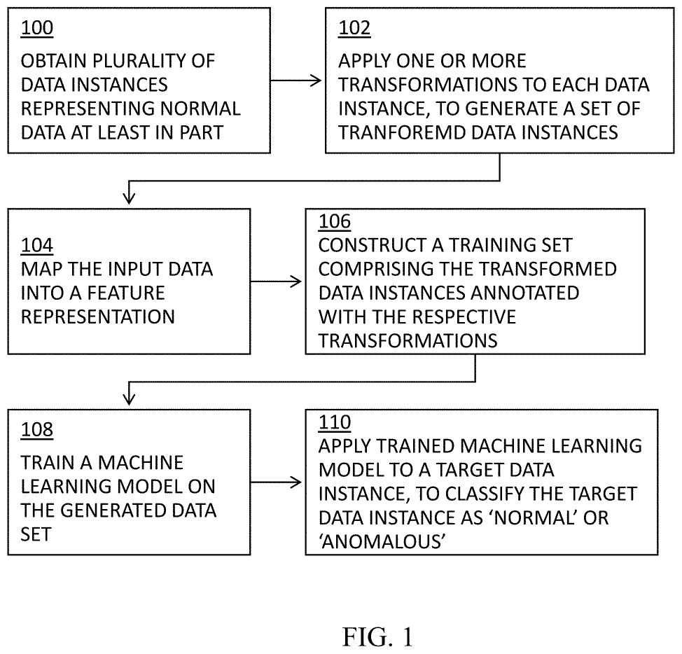

FIG. 1 is a flowchart of the functional steps in an automated machine learning-based detection of anomalous patterns in general data, according to some embodiments of the present disclosure.

In some embodiments, at step 100, the present method receives input data comprising a plurality of data instances x₁; x₂ . . . x_{N} that are, at least in part, ‘normal,’ i.e., belong to a ‘normal’ class or data instance within a data space.

In some embodiments, at step 102, the present method transforms each data instance in the input data using a set of transformations M into a transformed set of data instances T(x,1) . . . T(x,M).

In some embodiments, at step 104, the present method learns a feature extractor f(x) using a neural network, which maps the original input data into a feature representation, comprising a plurality of subspaces corresponding to the transformations. In some embodiments, each subspace Xₘ is mapped to the feature space {f(x)|x∈Xₘ} as a sphere with center cₘ.

In some embodiments, at step 106, the present method provides for constructing a self-annotated and/or self-labelled training dataset comprising the transformed data instances T(x,1) . . . T(x,M). In some embodiments, each transformed data instance in the training dataset may be labeled with its corresponding transformation label from set T=T₀, T₁, . . . , Tₘ.

In some embodiments, at step 108, a machine learning model, e.g., a classifier, may be trained on the training dataset constructed at step 106, to predict a transformation applied to the transformed data instance. In some embodiments, any suitable classification algorithm and/or architecture and optimization method may be used.

In some embodiments, an exemplary algorithm 1 for training a machine learning model of the present disclosure may be represented as:

Algorithm 1
Training Algorithm

Input: Normal training data x₁; x₂ ... x_{N}
Transformations T(, 1),T(, 2) ... T (, M)
Output: Feature extractor f, centers c₁, c₂ ... c_{M}
T(xᵢ, 1), T(xᵢ, 2)...T(xᵢ, M) ← xᵢ
// Transform each sample by all transformations 1 to M
Find f, c₁, c₂ ... c_{M} that optimize the triplet loss in (Eq. 3)

In some embodiments, the probability of a data instance x after transformation m is parameterized by

$$P ( T ( x , m ) ∈ {X}_{m ′} ) = \frac{1}{Z} {e}^{- {( f ( T ( x , m ) ) - {c}_{m ′} )}^{2}} .$$

The classifier predicting transformation m given a transformed data instance is therefore:

$$P ( {m}^{′} \vert T ( x , m ) ) = \frac{{e}^{- {‖ f ( T ( x , m ) ) - {c}_{m ′} ‖}^{2}}}{{\sum }_{\tilde{m}} {e}^{- {‖ f ( T ( x , m ) ) - {c}_{\tilde{m}} ‖}^{2}}} \qquad ( 2 )$$

The centers cₘ are given by the average feature over the training set for every transformation, i.e.,

$${c}_{m} = \frac{1}{N} {\sum }_{x ∈ X} f ( T ( x , m ) ) .$$

One option is to directly learn feature space f by optimizing cross-entropy between P(m′|T(x,m)) and the correct label on the normal training set. In some embodiments, f may be learned using center triplet loss, which learns supervised clusters with low intra-class variation and high inter-class variation, by optimizing the following loss function (where s is a margin regularizing the distance between clusters):

L=Σᵢ max(∥f(T(xᵢ,m))−cₘ∥²+s−min_{m′≠m}∥f(T(xᵢ,m))−c_{m′}∥²,0) (3)

In other embodiments, as an alternative to the open set method, a closed set method may be employed, wherein a classifier may be trained on top of the feature extractor $f(T(x,m))$ with a softmax loss. In this case, the predicted transformation probabilities are given by the outputs of the softmax layer. In some embodiments, both an open-set and closed-set losses may be employed jointly.

In some embodiments, at inference step 110, a trained machine learning model of the present method may be applied to a target data instance, to classify the target data instance as ‘normal’ or anomalous. In some embodiments, a classification by a trained classifier of the present disclosure may output a classification probability, e.g., a probability represented in Eq. 2 above.

In some embodiments, a target data instance may be transformed using transformations set T(, 1), T(, 2) . . . T(, M). In some embodiments, a trained machine learning model of the present disclosure may be applied to each of the transformations of the target data instance, to predict the respective transformations applied to the target data instance. In some embodiments, the classification probability represents a likelihood of accurately predicting a transformation applied to the target data instance. In some embodiments, an aggregated value of all classification probabilities may be indicative of a of a normality or anomaly of a target data point. In some embodiments, the aggregate of all classification probabilities may comprise an anomaly score.

In some embodiments, an exemplary algorithm 2 for inferencing a trained machine learning model of the present disclosure may be represented as:

Algorithm 2
Inferencing Algorithm

Input: Target sample: x, feature extractor: f, centers: c_1, c_2 ... c_M, transformations:
T(, 1),T(, 2) ... T (, M)
Output: Score(x)
T(x, 1), T(x, 2) ... T(x, M) ← x
// Transform test sample by all transformations 1 to M
P(m|T(x, m)) ← f(T(x, m)), c₁, c₂ ... c_{M}
// Likelihood of predicting the correct transformation (Eq. 4)
Score(x) P(1|T(x, 1)); P(2|T(x, 2)) ... P(M|T(x, M))
// Aggregate probabilities to compute anomaly score (Eq. 5)

may be used as a normality score. However, for data far away from the normal distributions, the distances from the means will be large. A small difference in distance will make the classifier unreasonably certain of a particular transformation. To add a general prior for uncertainty far from the training set, a small regularizing constant may be added to the probability of each transformation. This ensures equal probabilities for uncertain regions:

$$\tilde{P} ( {m}^{′} \vert T ( x , m ) ) = \frac{{e}^{- {‖ f ( T ( x , m ) ) - {c}_{m ′} ‖}^{2}} +}{{\sum }_{\tilde{m}} {e}^{- {‖ f ( T ( x , m ) ) - {c}_{\tilde{m}} ‖}^{2}} + M .} \qquad ( 4 )$$

At inference, each data sample may be transformed by the M transformations. By assuming independence between transformations, the probability that x is normal (i.e., x∈X) is the product of the probabilities that all transformed samples are in their respective subspace. For log-probabilities the total score is given by:

Score(x)=−log P(x∈X)=−Σₘ log \tilde{P}(T(x,m)∈Xₘ)=−Σₘ log \tilde{P}(m|T(x,m)) (5)

The score computes the degree of anomaly of each sample. Higher scores indicate a more anomalous sample.

### Parameterizing the Set of Transformations

Anomaly detection often deals with non-image datasets, e.g., tabular data. Tabular data is very commonly used on the internet, e.g., for cyber security or online advertising. Such data consists of both discrete and continuous attributes with no particular neighborhoods or order. The data is one-dimensional and rotations do not naturally generalize to it. To allow transformation-based methods to work on general data types, in some embodiments, the present disclosure provides for extending the class of transformations beyond those which work with respect to image data only.

Accordingly, in some embodiments, the present disclosure provides for a generalized set of transformations within the class of affine transformations:

T(x,m)=Wₘx+bₘ (6)

In some embodiments, this affine class is more general than mere permutations, and allows for dimensionality reduction, non-distance preservation and random transformation by sampling W, b from a random distribution.

Apart from reduced variance across different dataset types, where no a-priori knowledge on the correct transformation classes exists, random transformations are important for avoiding adversarial examples. Assume an adversary wishes to change the label of a particular sample from anomalous to normal or vice versa. This is the same as requiring that \tilde{P}(m′|T(x,m)) has low or high probability for m′=m. If T is chosen deterministically, the adversary may create adversarial examples against the known class of transformations (even if the exact network parameters are unknown). Conversely, if T is unknown, the adversary must create adversarial examples that generalize across different transformations, which reduces the effectiveness of the attack.

To summarize, generalizing the set of transformations to the affine class allows to: generalize to non-image data, use an unlimited number of transformations and choose transformations randomly, which reduces variance and defends against adversarial examples.

### Experimental Results

The present inventors performed experiments to validate the effectiveness of the present distance-based approach and the performance of the general class of transformations introduced for general data.

### Image Data Experiments

To evaluate the performance of the present method, the present inventors performed experiments on the Cifar10 dataset (see https://www.cs.toronto.edu/˜kriz/cifar.html). The present training algorithm wad used with respect to all training images, and the trained model inferenced on all test images. Results are reported in terms of AUC. In the present method, a margin of s=0.1 was used (another experiment was run with s=1, as shown further below). To stabilize training, a softmax+cross entropy loss was added, as well as L₂ norm regularization for the extracted features f(x). The present results were compared with the deep one-class method (see, Lukas Ruff et al. Deep one-class classification. In ICML, 2018) as well as with Golan & El-Yaniv (2018) (see, Izhak Golan and Ran El-Yaniv. Deep anomaly detection using geometric transformations. In NeurIPS, 2018), with and without Dirichlet weighting. The present distance based approach outperforms the SOTA approach by Golan & El-Yaniv (2018), both with and without Dirichlet. This gives evidence for the importance of considering the generalization behavior outside the normal region used in training. The results are shown in Table 1.

TABLE 1
Anomaly Detection Accuracy on Cifar10 (ROC-AUC %)

| | Method | | | |
|---|---|---|---|---|
| | | GEOM | GEOM | Present |
| Class | Deep-SVDD | (no Dirichlet) | (w. Dirichlet) | Method |
| 0 | 61.7 ± 1.3 | 76.0 ± 0.8 | 74.7 ± 0.4 | 77.2 ± 0.6 |
| 1 | 65.9 ± 0.7 | 83.0 ± 1.6 | 95.7 ± 0.0 | 96.7 ± 0.2 |
| 2 | 50.8 ± 0.3 | 79.5 ± 0.7 | 78.1 ± 0.4 | 83.3 ± 1.4 |
| 3 | 59.1 ± 0.4 | 71.4 ± 0.9 | 72.4 ± 0.5 | 77.7 ± 0.7 |
| 4 | 60.9 ± 0.3 | 83.5 ± 1.0 | 87.8 ± 0.2 | 87.8 ± 0.7 |
| 5 | 65.7 ± 0.8 | 84.0 ± 0.3 | 87.8 ± 0.1 | 87.8 ± 0.6 |
| 6 | 67.7 ± 0.8 | 78.4 ± 0.7 | 83.4 ± 0.5 | 90.0 ± 0.6 |
| 7 | 67.3 ± 0.3 | 89.3 ± 0.5 | 95.5 ± 0.1 | 96.1 ± 0.3 |
| 8 | 75.9 ± 0.4 | 88.6 ± 0.6 | 93.3 ± 0.0 | 93.8 ± 0.9 |
| 9 | 73.1 ± 0.4 | 82.4 ± 0.7 | 91.3 ± 0.1 | 92.0 ± 0.6 |
| Average | 64.8 | 81.6 | 86.0 | 88.2 |

The present inventors further performed a comparison between the present method and Ruff et al. (2018) and Golan & El-Yaniv (2018) on the FashionMNIST dataset (see https://research.zalando.com/welcome/mission/research-projects/fashion-mnist/). The present model was run with s=1. The present method outperformed the reference methods. The results are shown in Table 2.

TABLE 2
Anomaly Detection Accuracy on FashionMNIST (ROC-AUC %)

| | Method | | | |
|---|---|---|---|---|
| | | GEOM | GEOM | Present |
| Class | Deep-SVDD | (no Dirichlet) | (w. Dirichlet) | Method |
| 0 | 98.2 | 77.8 ± 5.9 | 99.4 ± 0.0 | 94.1 ± 0.9 |
| 1 | 90.3 | 79.1 ± 16.3 | 97.6 ± 0.1 | 98.5 ± 0.3 |
| 2 | 90.7 | 80.8 ± 6.9 | 91.1 ± 0.2 | 90.8 ± 0.4 |
| 3 | 94.2 | 79.2 ± 9.1 | 89.9 ± 0.4 | 91.6 ± 0.9 |
| 4 | 89.4 | 77.8 ± 3.3 | 92.1 ± 0.0 | 91.4 ± 0.3 |
| 5 | 91.8 | 58.0 ± 29.4 | 93.4 ± 0.9 | 94.8 ± 0.5 |
| 6 | 83.4 | 73.6 ± 8.7 | 83.3 ± 0.1 | 83.4 ± 0.4 |
| 7 | 98.8 | 87.4 ± 11.4 | 98.9 ± 0.1 | 97.9 ± 0.4 |
| 8 | 91.9 | 84.6 ± 5.6 | 90.8 ± 0.1 | 98.9 ± 0.1 |
| 9 | 99.0 | 99.5 ± 0.0 | 99.2 ± 0.0 | 99.2 ± 0.3 |
| Average | 92.8 | 79.8 | 93.5 | 94.1 |

### Adversarial Robustness

Assume an attack model where the attacker knows the architecture and the normal training data and is trying to minimally modify anomalies to look normal. Accordingly, the present inventors examined the merits of two settings: (i) the adversary knows the transformations used (non-arbitrary), and (ii) the adversary uses another set of transformations. To measure the benefit of the transformations, three networks A, B, C were trained. Networks A and B use exactly the same transformations, with a random parameter initialization prior to training. Network C is trained using other randomly selected transformations. The adversary creates adversarial examples using PGD (see Aleksander Madry et al. Towards deep learning models resistant to adversarial attacks. arXiv preprint arXiv:1706.06083, 2017) based on network A (making anomalies appear like normal data). On Cifar10, 8 transformations were selected from the full set of 72 for A and B, another set of randomly selected 8 transformations are used for C. The increase of false classification rate on the adversarial examples is measured using the three networks. The average increase in performance of classifying transformation correctly on anomalies (causing lower anomaly scores) on the original network A was 12.8%, the transfer performance for B causes an increase of 5.0% on network B, which shared the same set of transformation, and 3% on network C, which used other rotations. This shows the benefits of using random transformations.

### Tabular Data Experiments

The present inventors evaluated the present method on small-scale medical datasets, including datasets related to arrhythmia and thyroid, as well as large-scale cyber intrusion detection datasets (KDD and KDDRev). All reference methods were trained on 50% of the normal data. The reference methods were also evaluated on 50% of the normal data as well as all the anomalies.

The databases included the following:
Arrhythmia: A cardiology dataset from the UCI repository (Asuncion & Newman, 2007) containing attributes related to the diagnosis of cardiac arrhythmia in patients. The datasets consists of 16 classes: class 1 are normal patients, 2-15 contain different arrhythmia conditions, and class 16 contains undiagnosed cases. The smallest classes: 3, 4, 5, 7, 8, 9, 14, 15 are taken to be anomalous and the rest normal. Also following ODDS, the categorical attributes are dropped, the final attributes total 274.
Thyroid: A medical dataset from the UCI repository (Asuncion & Newman, 2007), containing attributes related to whether a patient is hyperthyroid. Following ODDS (Rayana, 2016), from the 3 classes of the dataset, hyperfunction was designated as the anomalous class and the rest as normal. Also following ODDS only the 6 continuous attributes are used.
KDD: The KDD Intrusion Detection dataset was created by an extensive simulation of a US Air Force LAN network. The dataset consists of the normal and 4 simulated attack types: denial of service, unauthorized access from a remote machine, unauthorized access from local superuser and probing. The dataset consists of around 5 million TCP connection records. The UCI KDD 10% dataset is used, which is a subsampled version of the original dataset. The dataset contains 41 different attributes. 34 are continuous and 7 are categorical. The categorical attributes are encoded using 1-hot encoding. Two different settings for the KDD dataset are evaluated:
   KDDCUP99: In this configuration, the entire UCI 10% dataset was sued. As the non-attack class consists of only 20% of the dataset, it is treated as the anomaly in this case, while attacks are treated as normal.
   KDDCUP99-Rev: To better correspond to the actual use-case, in which the non-attack scenario is normal and attacks are anomalous, the reverse configuration was used in which the attack data is sub-sampled to consist of 25% of the number of non-attack samples. The attack data is in this case designated as anomalous (the reverse of the KDDCUP99 dataset).

In all the above datasets, the methods are trained on 50% of the normal data. The methods are evaluated on 50% of the normal data as well as all the anomalies.

Reference methods evaluated were:
One-Class SVM (OC SVM) (see Bernhard Scholkopf et al. Support vector method for novelty detection. In NIPS, 2000).
End-to-End Autoencoder (E2E-AE).
Local Outlier Factor (LOF) (see Markus M Breunig et al. Lof: identifying density based local outliers. In ACM sigmod record, volume 29, pp. 93-104. ACM, 2000).
Deep autoencoding gaussian mixture model (DAGMM) (see Bo Zong et al. Deep autoencoding gaussian mixture model for unsupervised anomaly detection. ICLR, 2018).

To compare against ensemble methods, the inventors implemented the Feature Bagging Autoencoder (FB-AE) with autoencoders as the base classifier, feature bagging as the source of randomization, and average reconstruction error as the anomaly score. OC-SVM, E2E-AE and DAGMM results are directly taken from those reported by Zong (2018). LOF and FB-AE were computed by the present inventors.

The present method was implemented by randomly sampling transformation matrices using the normal distribution for each element. Each matrix has dimensionality L×r, where L is the data dimension and r is a reduced dimension. For arryhthmia and thyroid r=32 was used, and for KDD and KDDrev r=128 and r=64 were used, respectively (the latter due to high memory requirements). Two-hundred and fifty-six tasks were used for all datasets, apart from KDD (64) due to high memory requirements. The bias term was set to 0. For C, fully-connected hidden layers and leaky-ReLU activations were used (8 hidden nodes for the small datasets, 128 and 32 for KDDRev and KDD). The model was optimized using ADAM with a learning rate of 0.001. To stabilize the triplet center loss training, a softmax+cross entropy loss was added. The large-scale experiments were repeated 5 times, and the small scale experiments 500 times (due to the high variance). The mean and standard deviation (σ) are reported below. The decision threshold value is chosen to result in the correct number of anomalies, e.g., if the test set contains Nₐ anomalies, the threshold is selected so that the highest Nₐ scoring examples are classified as anomalies. True positives and negatives are evaluated in the usual way. Some experiments copied from other papers did not measure standard variation and it the relevant cell was kept blank.

Table 3 below presents quantitative comparison results with respect to the tabular data experiment. The arrhythmia dataset was the smallest examined. OC-SVM and DAGMM performed reasonably well. The present method is comparable to FB-AE. A linear classifier C performed better than deeper networks (which suffered from overfitting). Early stopping after a single epoch generated the best results.

The thyroid dataset is a small dataset, with a low anomaly to normal ratio and low feature dimensionality. Most reference methods performed about equally well, probably due to the low dimensionality. On this dataset, it was also found that early stopping after a single epoch gave the best results. The best results on this dataset were obtained with a linear classifier. The present method is comparable to FB-AE and beat all other reference methods by a wide margin.

The UCI KDD 10% dataset is the largest dataset examined. The strongest reference methods are FB-AE and DAGMM. The present method significantly outperformed all reference methods. It was found that large datasets have different dynamics from very small datasets. On this dataset, deep networks performed the best. The results are reported after 25 epochs.

The KDD-Rev dataset is a large dataset, but smaller than KDDCUP99 dataset. Similarly to KDDCUP99, the best reference methods were FB-AE and DAGMM, where FB-AE significantly outperforms DAGMM. The present method significantly outperformed all reference methods. The results are reported after 25 epochs.

Due to the large number of transformations and relatively small networks, adversarial examples are less of a problem for tabular data. PGD generally failed to obtain adversarial examples on these datasets. On KDD, transformation classification accuracy on anomalies was increased by 3.7% for the network the adversarial examples were trained on, 1.3% when transferring to the network with the same transformation, and only 0.2% on the network with other randomly selected transformations. This again shows increased adversarial robustness due to random transformations.

TABLE 3
Anomaly Detection Accuracy (%)

| | Dataset | | | | | | | |
|---|---|---|---|---|---|---|---|---|
| | Arrhythmia | | Thyroid | | KDD | | KDDRev | |
| | F₁ | | F₁ | | F₁ | | F₁ | |
| Method | Score | σ | Score | σ | Score | σ | Score | σ |
| OC-SVM | 45.8 | | 38.9 | | 79.5 | | 83.2 | |
| E2E-AE | 45.9 | | 11.8 | | 0.3 | | 74.5 | |
| LOF | 50.0 | 0.0 | 52.7 | 0.0 | 83.8 | 5.2 | 81.6 | 3.6 |
| DAGMM | 49.8 | | 47.8 | | 93.7 | | 93.8 | |
| FB-AE | 51.5 | 1.6 | 75.0 | 0.8 | 92.7 | 0.3 | 95.9 | 0.4 |
| Present | 52.0 | 2.3 | 74.5 | 1.1 | 98.4 | 0.2 | 98.9 | 0.3 |
| Method | | | | | | | | |

### Further Analysis

### Contaminated Data

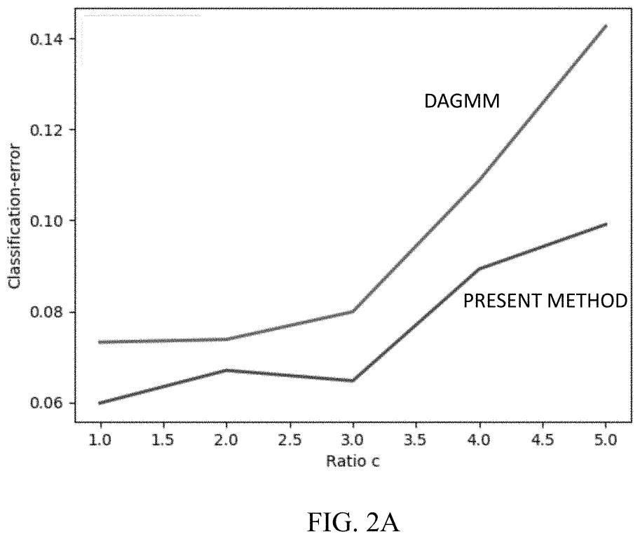

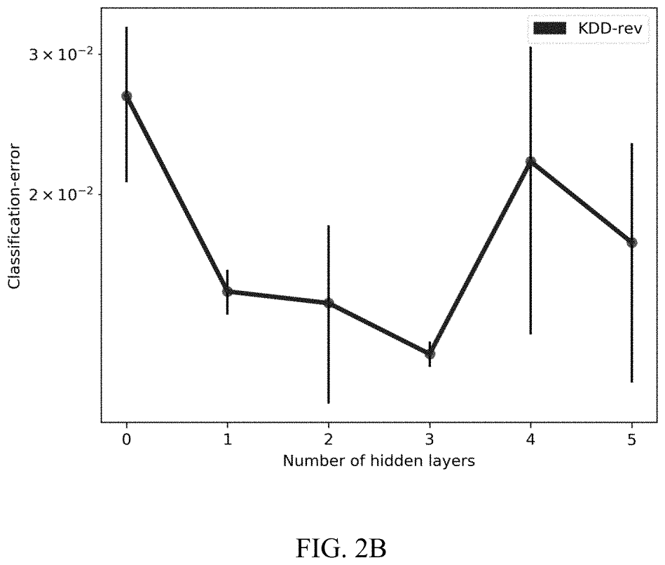

The present method provides for a semi-supervised scenario, i.e., when the training dataset contains only normal data. In some scenarios, such data might not be available, such that a training data might contain a small percentage of anomalies. To evaluate the robustness of the present method to this unsupervised scenario, the KDDCUP99 dataset was analyzed when X % of the training data is anomalous. To prepare the data, the same normal training data was used as before, with added anomalous examples. The test data consists of the same proportions as before. The results are shown in FIGS. 2A-2B. FIG. 2A shows classification error for the present method and DAGMM as a function of percentage of the anomalous examples in the training set (on the KDDCUP99 dataset). The present method consistently outperforms the reference method. FIG. 2B shows classification error as a function of the number of transformations (on the KDDRev dataset). As can be seen, the error and instability decrease as a function of the number of transformations.

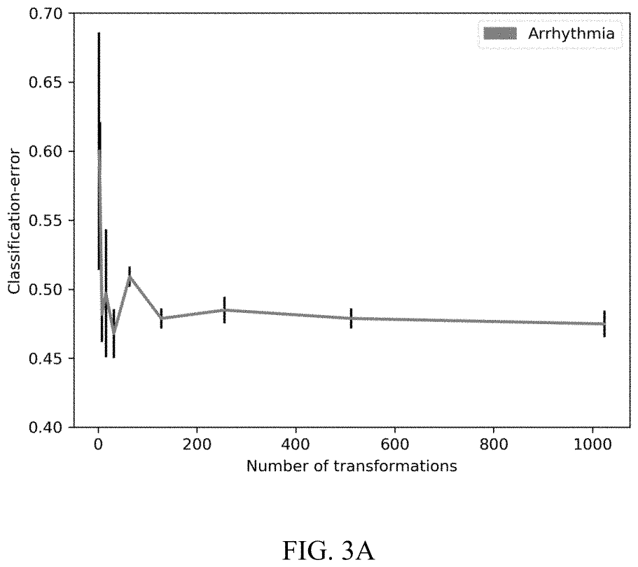

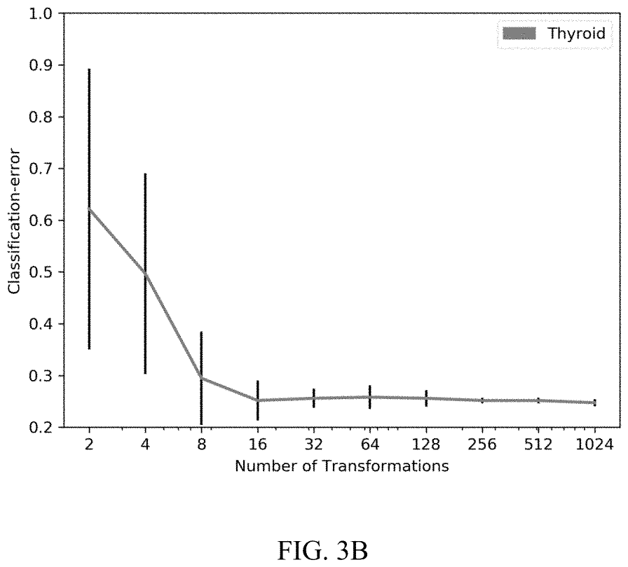

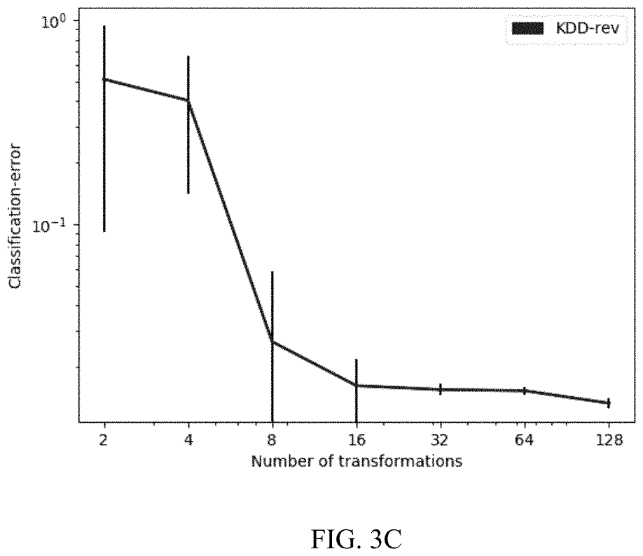

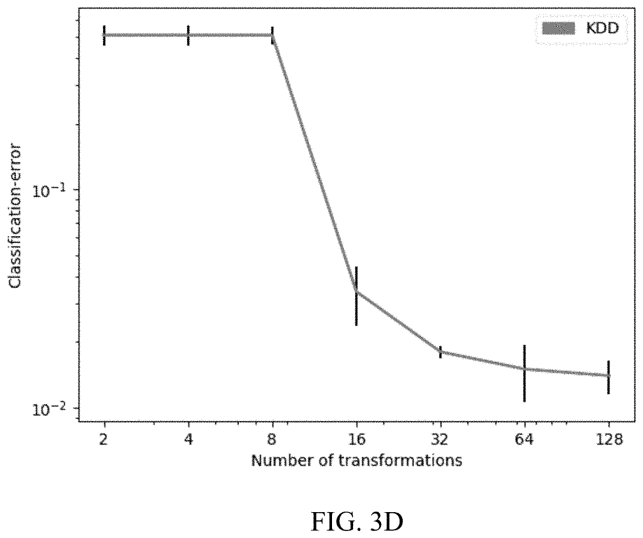

Accordingly, the present method significantly outperforms DAGMM for all impurity values, and degrades more graceful than the baseline. This attests to the effectiveness of the present approach. Results for the other datasets are presented in FIGS. 3C (KDDCup99) and 3D (arrhythmia), showing similar robustness to contamination.

### Number of Tasks

One of the advantages of the present method is the ability to generate any number of tasks. The anomaly detection performance on the KDD-Rev dataset is presented with different numbers of tasks in FIG. 3A. Note that a small number of tasks (fewer than 16) leads to poor results. Above 16 tasks, the accuracy remains stable. It was found that on the smaller datasets (thyroid, arrhythmia), using a larger number of transformations continued to reduce F₁ score variance between differently initialized runs. FIGS. 3A-3D show plots of the number of auxiliary tasks vs. the anomaly detection accuracy (measured by F1) with respect to each dataset (FIG. 3A—arrhythmia, FIG. 3B—thyroid, FIG. 3C—KDDRev, and FIG. 3D—KDDCup99). As can be seen, accuracy often increases with the number of tasks, although the increase rate diminishes with the number of tasks.

Openset vs. Softmax

The openset-based classification presented by the present method resulted in performance improvement over the closed-set softmax approach on Cifar10 and FasionMNIST. In the present experiments, it has also improved performance in KDDRev. Arrhythmia and thyroid were comparable. As a negative result, performance of softmax was better on KDD (F₁=0.99).

### Choosing the Margin Parameter s

The present method is not particularly sensitive to the choice of margin parameter s, although choosing s that is too small might cause some instability. A fixed value of s=1 was sued in the present experiments.

### Other Transformations

The present method can also work with other types of transformations, such as rotations or permutations for tabular data. In the present experiments, it was observed that these transformation types perform comparably but a little worse than affine transformations.

### Unsupervised Training

Although most of the present results are semi-supervised, i.e., assume that no anomalies exist in the training set, results are presented showing that the present method is more robust than strong reference methods to a small percentage of anomalies in the training set. Results in other datasets are further presented showing that the present method degrades gracefully with a small amount of contamination. The present method might therefore be considered in the unsupervised settings.

Deep vs. Shallow Classifiers

The present experiments show that for large datasets, deep networks are beneficial (particularly for the full KDDCup99), but are not needed for smaller datasets (indicating that deep learning has not benefited the smaller datasets). For performance critical operations, the present approach may be used in a linear setting. This may also aid future theoretical analysis of the present method.

### Further Experiments

### Image Datasets—Sensitivity to Margin S

The present inventors ran the Cifar10 experiments (see above) with s=0: 1 and s=1. The results are presented in Table 4 below. As can be seen, the results were not affected significantly by the margin parameter. This is in-line with the rest of the empirical observations that the present method is not very sensitive to the margin parameter.

TABLE 4
Anomaly Detection Accuracy on Cifar10 (%)

| | Method | | |
|---|---|---|---|
| | | Present | Present |
| | GEOM | Method | Method |
| Class | (w. Dirichlet) | (s = 0.1) | s = 1.0) |
| 0 | 74.7 ± 0.4 | 77.2 ± 0.6 | 77.9 ± 0.7 |
| 1 | 95.7 ± 0.0 | 96.7 ± 0.2 | 96.4 ± 0.9 |
| 2 | 78.1 ± 0.4 | 83.3 ± 1.4 | 81.8 ± 0.8 |
| 3 | 72.4 ± 0.5 | 77.7 ± 0.7 | 77.0 ± 0.7 |
| 4 | 87.8 ± 0.2 | 87.8 ± 0.7 | 87.7 ± 0.5 |
| 5 | 87.8 ± 0.1 | 87.8 ± 0.6 | 87.8 ± 0.7 |
| 6 | 83.4 ± 0.5 | 90.0 ± 0.6 | 90.9 ± 0.5 |
| 7 | 95.5 ± 0.1 | 96.1 ± 0.3 | 96.1 ± 0.2 |
| 8 | 93.3 ± 0.0 | 93.8 ± 0.9 | 93.3 ± 0.1 |
| 9 | 91.3 ± 0.1 | 92.0 ± 0.6 | 92.4 ± 0.3 |
| Average | 86.0 | 88.2 | 88.1 |

### Contamination Experiments

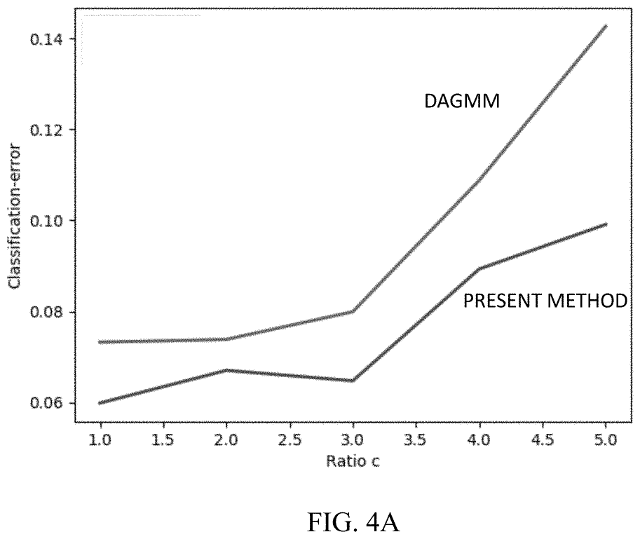

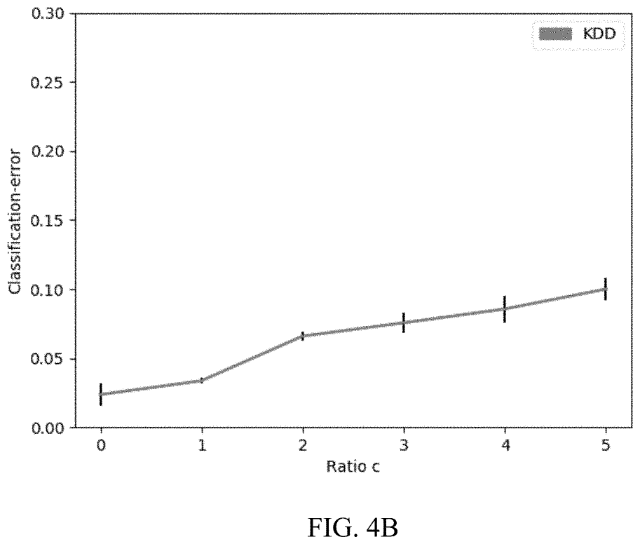

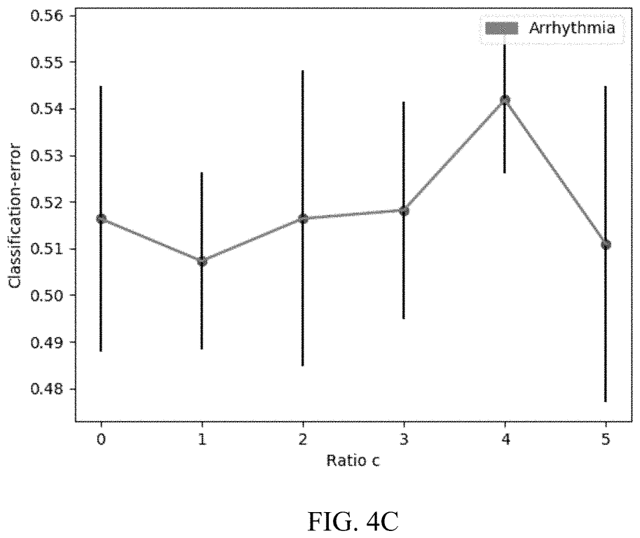

We conduct contamination experiments for 3 datasets. Thyroid was omitted due to not having a sufficient number of anomalies. The protocol is different than that of KDDRev as we do not have unused anomalies for contamination. Instead, we split the anomalies into train and test. Train anomalies are used for contamination, test anomalies are used for evaluation. As DAGMM did not present results for the other datasets, we only present GOAD. GOAD was reasonably robust to contamination on KDD, KDDRev and Arrhythmia. The results are presented in FIGS. 4A-4C.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1. A system comprising:
at least one hardware processor; and
a non-transitory computer-readable storage medium having stored thereon program instructions, the program instructions executable by the at least one hardware processor to:
receive, as input, a plurality of data instances representing, at least in part, normal data, wherein said data instances include non-image data instances,
apply, to each of said data instances, one or more transformations selected from a set of transformations, to generate a set of transformed data instances, and
at a training stage, train a machine learning model on a training set comprising:
(i) said set of transformed data instances, and
(ii) labels indicating said transformation applied to each of said transformed data instances in said training set,
to obtain a trained machine learning model configured to be applied to a target data instance, to predict a transformation from said set of transformations applied to said target data instance.

2. The system of claim 1, wherein said program instructions are further executable to, at an inference stage, apply said trained machine learning model to said target data instance, to predict a transformation from said set of transformations applied to said target data instance.

3. The system of claim 1, wherein said prediction has a confidence score, and wherein said confidence score is indicative of an anomaly value associated with said target data instance.

4. (canceled)

5. The system of claim 3, wherein said normal data is within a distribution, and wherein said anomaly value indicates how far said target data instance is from said distribution.

6. (canceled)

7. (canceled)

8. The system of claim 1, wherein said data instances are selected from the group comprising: numerical data, univariate time-series data, multivariate time-series data, attribute-based data, vectors, graph data, and tabular data.

9. The system of claim 1, wherein said one or more transformations comprise non-distance preservation transformations.

10. The system of claim 1, wherein said one or more transformations are selected from the group comprising: geometric transformations, permutations, orthogonal matrices, affine matrices, application of a neural network, logarithmic transformations, exponential transformations, and multiplication operations.

11. (canceled)

12. A method comprising:
receiving, as input, a plurality of data instances representing, at least in part, normal data, wherein said data instances include non-image data;
applying, to each of said data instances, one or more transformations selected from a set of transformations, to generate a set of transformed data instances; and
at a training stage, training a machine learning model on a training set comprising:
(i) said set of transformed data instances, and
(ii) labels indicating said transformation applied to each of said transformed data instances in said set;
to obtain a trained machine learning model configured to be applied to a target data instance, to predict a transformation from said set of transformations applied to said target data instance.

13. The method of claim 12, further comprising, at an inference stage, applying said trained machine learning model to said target data instance, to predict a transformation from said set of transformations applied to said target data instance.

14. The method of claim 12, wherein said prediction has a confidence score, and wherein said confidence score is indicative of an anomaly value associated with said target data instance.

15. (canceled)

16. The method of claim 14, wherein said normal data is within a distribution, and wherein said anomaly value indicates how far said target data instance is from said distribution.

17. (canceled)

18. (canceled)

19. The method of claim 12, wherein said non-image data instances are selected from the group comprising: numerical data, univariate time-series data, multivariate time-series data, attribute-based data, vectors, graph data, and tabular data.

20. The method of claim 12, wherein said one or more transformations comprise non-distance preservation transformations.

21. The method of claim 12, wherein said one or more transformations are selected from the group comprising: geometric transformations, permutations, orthogonal matrices, affine matrices, application of a neural network, logarithmic transformations, exponential transformations, and multiplication operations.

22. (canceled)

23. A computer program product comprising a non-transitory computer-readable storage medium having program code embodied therewith, the program code executable by at least one hardware processor to:
receive, as input, a plurality of data instances representing, at least in part, normal data, wherein said data instances include non-image data instances;
apply, to each of said data instances, one or more transformations selected from a set of transformations, to generate a set of transformed data instances; and
at a training stage, train a machine learning model on a training set comprising:
(i) said set of transformed data instances, and
(ii) labels indicating said transformation applied to each of said transformed data instances in said set,
to obtain a trained machine learning model configured to be applied to a target data instance, to predict a transformation from said set of transformations applied to said target data instance.

24. The computer program product of claim 23, wherein said program instructions are further executable to, at an inference stage, apply said trained machine learning model to said target data instance, to predict a transformation from said set of transformations applied to said target data instance.

25. The computer program product of claim 23, wherein said prediction has a confidence score, and wherein said confidence score is indicative of an anomaly value associated with said target data instance.

26. (canceled)

27. The computer program product of claim 23, wherein said normal data is within a distribution, and wherein said anomaly value indicates how far said target data instance is from said distribution.

28. (canceled)

29. (canceled)

30. The computer program product of claim 23, wherein said non-image data instances are selected from the group comprising: numerical data, univariate time-series data, multivariate time-series data, attribute-based data, vectors, graph data, and tabular data.

31. The computer program product of claim 23, wherein said one or more transformations comprise non-distance preservation transformations.

32. (canceled)

33. (canceled)
